(19) United States
(12) Patent Application Publication
(10) Pub. No.: US 2011/0045835 A1
(43) Pub. Date: Feb. 24, 2011

(54) SELF-CONFIGURATION OF FEMTOCELL ACCESS POINTS (FAP)

(76) Inventors: Joey Chou, Scottsdale, AZ (US); Pouya Taaghol, San Jose, CA (US)

Correspondence Address: MISSION/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/796,535

(22) Filed: Jun. 8, 2010

Related U.S. Application Data
(60) Provisional application No. 61/236,056, filed on Aug. 21, 2009.

(51) Int. Cl. H04W 40/00

(52) U.S. Cl. 455/446

(57) ABSTRACT

An approach to support self-configuring feature on femtocell access points (FAP) is disclosed. A FAP may scan the neighboring base-stations provisioned in the network environment to collect the base-station identifiers of the neighboring base-stations. The FAP may detect a self-organizing server, which in turn may cooperatively operate with an OAM&P server to provide configuration values to the FAP. The FAP may automatically perform self-configuration without any or minimal user intervention. Such an approach may avoid cumbersome tasks of manual configuration and deployment of FAPs or avoiding the truck-roll.

### CROSS-REFERENCE TO RELATED APPLICATIONS

The present application claims the benefit of U.S. provisional application Ser. No. 61/236,056, filed Aug. 21, 2009, (docket # P82109Z), the entire content of which is incorporated by reference herein.

### BACKGROUND

Rapid development in broadband access technologies has led to a faster deployment of broadband services in homes, offices and enterprises, and cities and towns. To enable wireless broadband access, the service providers have started deploying overlaid macro base stations (OMBS). The service provides that deploy OMBS may track or maintain the location of the OMBS and the attributes that may be used to provision each of the OMBS. As the number of OMBS that need to be deployed are less compared to the femtocell access points (FAP), it may be comparatively easier for the service provider to deploy the OMBS to insure that the OMBS in a serving area operate harmoniously.

There is a substantial increase in the number of mobile users wanting to access both voice and data services with a good network coverage from wherever they are positioned. Especially, many a times the mobile network coverage may be annoyingly poor within homes and small office buildings that may cause frustration to mobile users. To improve the quality of mobile or cellular coverage, the service providers are planning to deploy huge number of femtocell access points (FAP) in homes and small offices and such other places. Such huge deployments of FAPs are expected to improve the mobile coverage, substantially, within homes, small offices, and such other places. However, performing the truck roll of FAPs or managing the FAPs manually will be a great burden on the operators.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a network environment 100.

FIG. 2 illustrates a state-diagram 200 for enabling self configuration of the femtocell access points (FAP) in accordance with one embodiment.

FIG. 3 is a block diagram of a femtocell access point (FAP), which may support self-configuration of the FAP in accordance with one embodiment.

FIG. 4 is a flow-chart 400, which illustrates the operation of the FAP while performing self-configuration in accordance with one embodiment.

FIGS. 5A and 5B, respectively, illustrate a parameters table 365 and a configuration table 375, which the FAP may use to perform self-configuration in accordance with one embodiment.

FIG. 6 is a block diagram of a first server, which may support self-configuration of the FAP in accordance with one embodiment.

FIG. 7 illustrates a configuration table 770 populated by the first server after receiving a response from the SON server in accordance with one embodiment.

FIG. 8 is a flow-chart 800, which illustrates the operation of the first server while supporting the FAP to perform self-configuration in accordance with one embodiment.

FIG. 9 is a block diagram of a second server, which may support self-configuration of the FAP in accordance with one embodiment.

FIG. 10 is a flow-chart 1000, which illustrates the operation of the second server while supporting the FAP to perform self-configuration in accordance with one embodiment.

### DETAILED DESCRIPTION

The following description describes a self-configuration technique performed by a femtocell access point (FAP). In the following description, numerous specific details such as logic implementations, resource partitioning, or sharing, or duplication implementations, types and interrelationships of system components, and logic partitioning or integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable storage medium may include any mechanism for storing or transmitting information in a form readable by a machine (e.g., a computing device).

For example, a machine-readable storage medium may include read only memory (ROM); random access memory (RAM); magnetic disk storage media; optical storage media; flash memory devices; electrical, optical forms of signals. Further, firmware, software, routines, and instructions may be described herein as performing certain actions. However, it should be appreciated that such descriptions are merely for convenience and that such actions in fact result from computing devices, processors, controllers, and other devices executing the firmware, software, routines, and instructions.

In one embodiment, the femtocell access points (FAP) may perform self-configuration, which may enable the FAPs to operate harmoniously with the neighboring FAPs (NFAP) and overlaid macro base stations (OMBS). In one embodiment, a serving FAP may scan the neighboring FAPs (NFAP) and overlaid macro base stations (OMBS). In response to scanning, the serving FAP may receive the base station identifiers (BSID) of the base-stations such as neighboring FAPs (NFAP) and OMBS provisioned in the network. In one embodiment, the signal strength of each of the NFAPs and the OMBSs, which may respond to the scan signal, may be determined.

In one embodiment, the serving FAP may then determine a self-organizing network (SON) server to which a list of BSIDs and the corresponding RSSIs may be sent. In one embodiment, the SON server may send the list of BSIDs to an OAM&P server and in response may receive configuration data, associated with each base-station identified in the list, from the OAM&P server. In one embodiment, the SON server may generate the configuration parameters specific for the serving FAP from the configuration data and send the configuration parameters to the serving FAP. In one embodiment, the serving FAP may then receive one or more configuration parameters/values such as medium access control (MAC) values and physical (PHY) layer values from the SON server. In one embodiment, the serving FAP may use the configuration parameters/values to perform self-configuration, which may avoid manual management of the FAPs.

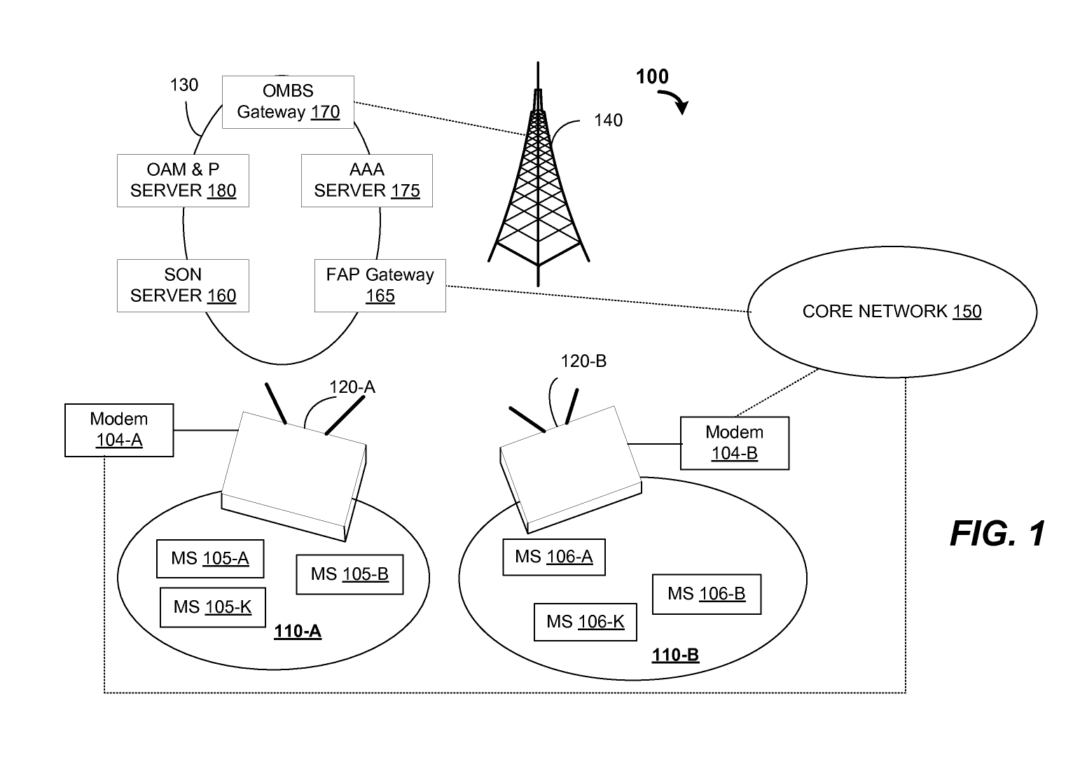

An embodiment of a network environment 100 in which femtocell access points (FAPs) that may perform self-configuration may be deployed is illustrated in FIG. 1. In one embodiment, the network environment 100 may include mobile coverage areas 110-A and 110-B, femtocell access points 120-A and 120-B, a wireless network 130, an overlaid macro base station OMBS 140, and a core network 150. In one embodiment, the wireless network 130 may include a self-organizing network server (SON) 160, FAP gateway 165, an overlaid OMBS (OMBS) gateway 170, an AAA server 175, and an operation, administration, maintenance, and provisioning (OAM&P) server 180. In one embodiment, the FAP 120-A and FAP 120-B may be coupled to the FAP gateway 165 via the core network 150 using modems 104-A and 104-B. In one embodiment, the mobile coverage areas 110-A and 110-B may, respectively, include one or more mobile stations MS 105-A, MS 105-B, and 105-K and MS 106-A, MS 106-B, and MS 106-K. In one embodiment, the core network 150 may include public switching telephone network (PSTN), Internet protocol (IP) based networks, and such other networks.

In one embodiment, the network environment 100 may comprise many more FAPs and OMBS similar to the FAP 120 and the OMBS 140. In one embodiment, the FAP 120-A may be referred to as a “serving FAP” (SFAP) and the serving FAP 120-A may scan neighboring FAPs (NFAP) such as NFAP 120-B and overlaid macro base-stations such as the OMBS 140. In one embodiment, the serving FAP 120-A may receive a broadcast signal from the neighboring FAPs such as NFAP 120-B and overlaid macro base-stations such as OMBS 140 at regular intervals of time. In one embodiment, the broadcast signal may comprise base-station identifiers (BSID) of the neighboring FAPs and OMBS. In one embodiment, the serving FAP 120-A may receive base-station identifiers (BSID) from the FAPs such as NFAP 120-B and OMBSs such as OMBS 140 in a broadcast message sent from the neighboring FAPs and OMBS at regular intervals or in response to occurrence of specific events or triggers. In other embodiment, the serving FAP 120-A may receive the BSID from a downlink map (DL-MAP) broadcast message sent by the responding NFAPs 120-B and OMBS 140.

In one embodiment, the serving FAP 120-A may receive the identifiers or BSID from the neighboring NFAPs and OMBS and determine the radio signal strength indicator (RSSI) for the responding NFAPs and OMBSs. In one embodiment, the serving FAP 120-A may determine RSSI-A and RSSI-B, respectively, for the NFAP 120-A and OMBS 140 in response to receiving base-station identifiers (BSIDs) from the NFAP 120-B and OMBS 140. In one embodiment, the serving FAP 120-A may send the combination of BSID and the corresponding RSSI value for each base-station to the SON server 160. In one embodiment, the serving FAP 120-A may receive one or more configuration parameters/values from the SON server 160 in response to sending the combinations of BSID and RSSI. In one embodiment, the configuration values may include MAC and PHY configuration data and other attributes such as transmission power, uplink center frequency, downlink center frequency, and preamble sequence. In one embodiment, the serving FAP 120-A may use the configuration data to configure the attributes, which may facilitate normal operation of the serving FAP 120-A. As the serving FAP 120-A performs its configuration, automatically, without manual intervention, the serving FAP 120-A may be referred to as a self-configuring FAP.

In one embodiment, the SON server 160 may receive BSID and RSSI for each base-station. In one embodiment, the SON server 160 may generate a query including the selected BSIDs and then send the query or queries to the OAM&P server 180. In one embodiment, the SON server 160 may receive MAC and PHY configuration data in response to the query sent to the OAM&P server 180.

In one embodiment, the SON server 160 may receive MAC and PHY configuration data for each BSID in the query. In one embodiment, the MAC and PHY configuration data may comprise PHY independent uplink channel characteristics, orthogonal frequency division multiplexing access (OFDMA) uplink channel characteristics, (OFDMA) uplink burst profiles, (OFDMA) downlink channel characteristics, OFDMA downlink burst profiles, and/or such other configuration data.

In one embodiment, the SON server 160 may use the MAC and PHY configuration data to determine configuration values for the serving FAP 120-A based on the neighboring base station configuration data. In one embodiment, the SON server 160 may add other attributes to the MAC and PHY configuration data received from the OAM&P server 180. In one embodiment, the other attributes may include transmission power, uplink center frequency, downlink center frequency, preamble sequence, and such other attributes.

In one embodiment, the SON server 160 may use the RSSI values received from the serving FAP 120-A to prepare a preliminary list of neighboring devices. For example, the preliminary list may include OMBS 140 as OMBS 140 represents the overlaid macro base-station for the serving FAP 120-A. In addition to the overlaid OMBS, the SON server 160 may identify the neighboring FAPs such as NFAP 120-B, which may have a RSSI value satisfying handoff threshold, for example.

In one embodiment the SON server 160 may use the handoff threshold, for example, −50 dbm and any base-station in the neighborhood of the serving FAP 120-B that has a RSSI value greater than −50 dbm may qualify to the preliminary list of neighboring devices. In one embodiment, the SON server 160 may dynamically populate the neighboring list if the RSSI of the neighboring base-stations exceed the handoff threshold. In one embodiment, the preliminary list may be changed, dynamically, based on additional measurements received from the mobile stations 105 and 106. In one embodiment, the SON server 160 may send the configuration values to the serving FAP 120-A.

In one embodiment, the OAM&P server 180 may generate MAC and PHY configuration data in response to receiving the one or more queries from the SON server 160. In one embodiment, the MAC and PHY configuration data provided by the OAM&P server 180 may include PHY independent uplink channel characteristics, orthogonal frequency division multiplexing access (OFDMA) uplink channel characteristics, (OFDMA) uplink burst profiles, (OFDMA) downlink channel characteristics, OFDMA downlink burst profiles, and/or such other configuration data.

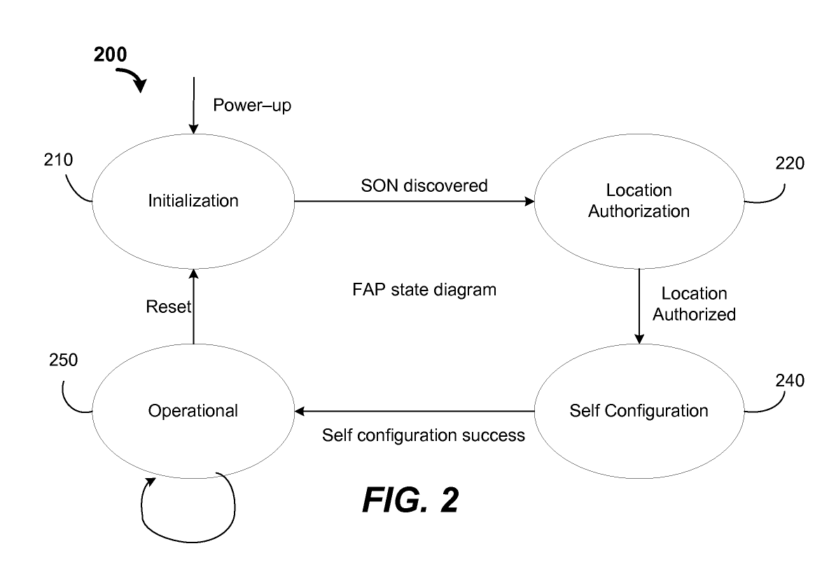

A state diagram 200 depicting a self-configuration operation of the serving femtocell access point (FAP) 120-A is illustrated in FIG. 2. In one embodiment, the state diagram 200 may be initiated on events such as power-on reset. In one embodiment, the serving FAP 120-A may enter an initialization phase 210 on detecting such initialization events. During the initialization phase 210, in one embodiment, the serving FAP 120-A may scan the neighborhood by sending a scanning signal and may receive identifiers of the base-stations in the neighborhood that may respond to the scan signal using a DL-MAP signal. In one embodiment, the serving FAP 120-A may determine the RSSI for each of the base-stations identified by an identifier (BSID). In one embodiment, the serving FAP 120-A may discover the SON server 160 during the initialization phase 210. A location authorization phase 220 may be reached on detecting the SON server 160.

During the location authorization phase 220, the SON server 160 may determine if the serving FAP 120-A is located in the authorized location. A self-configuration phase 240 may be reached, if the serving FAP 120-A is located in the authorized location. During the self-configuration phase 240, the serving FAP 120-A may scan the neighboring FAPs and OMBSes. In one embodiment, the BSID of each of the base-stations in the neighborhood of the serving FAP 120-A may be received as a result of serving FAP 120-A scanning the neighboring FAPs and OMBSes. Also, the scanning report may include RSSI values for each base-station represented the BSID. In one embodiment, the SON server 160 may send a query including one or more BSID taken from the report or may generate a multiple queries each having BSID of a base-station in the neighborhood. In one embodiment, the SON server 160 may receive MAC and PHY configuration data from the OAM&P server 180 in response to sending the query. In one embodiment, the SON server 160 may generate configuration values based on the MAC and PHY configuration data and may send such configuration values to the serving FAP 120-A. A self-configuration phase 240 may be reached in response to SON server 160 sending the configuration values to the serving FAP 120-A.

An operational phase 250 may be reached after self-configuration is successful. In one embodiment, the serving FAP 120-A may perform normal operation, which may include supporting voice and/or data transfer between the mobile stations MS 105 and 106 and the core network 150. The initialization phase 210 may be reached if a reset or any other such event may be detected during the operation phase 250.

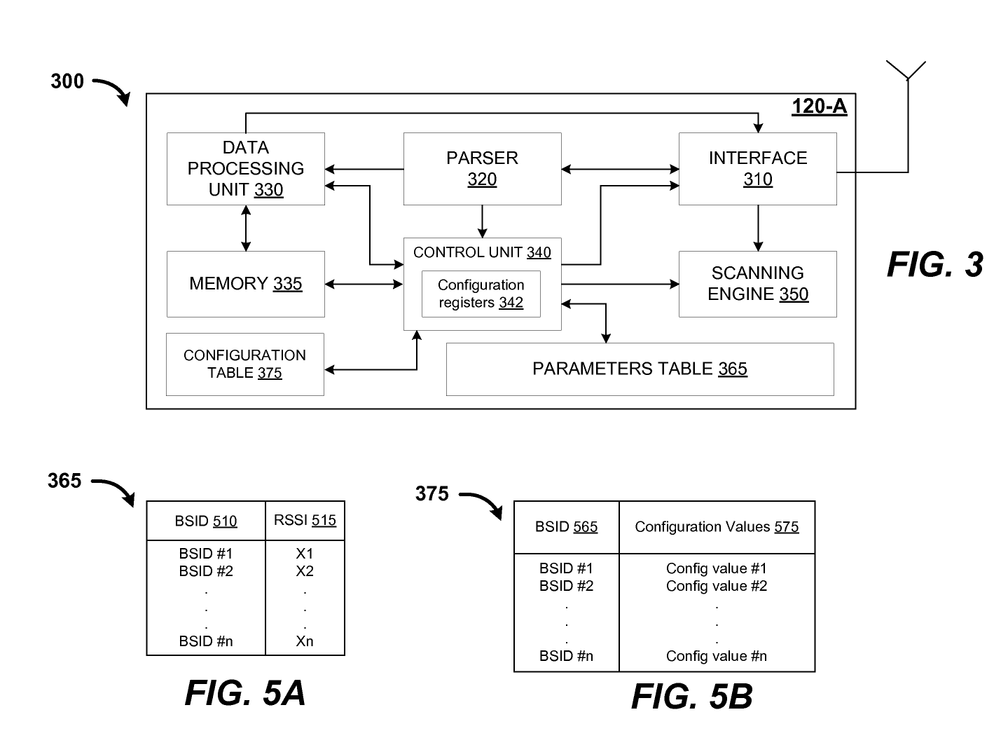

An embodiment of a serving FAP 120-A that may perform self-configuration is illustrated in FIG. 3. In one embodiment, the serving FAP 120-A may include an interface 310, a parse 320, a data processing unit 330, a memory 335, a control unit 340, a scanning engine 350, a parameters table 365, and a configuration table 375.

In one embodiment, the interface 310 may allow the serving FAP 120-A to communicate with the other blocks in the network environment 100. In one embodiment, the interface 310 may support wireless protocols such as IEEE Std 802.16™ accepted by the Institute of Electrical and Electronics Engineers. In one embodiment, the interface 310 may provide electrical, physical, and protocol interfaces to the other blocks in the network 100. In one embodiment, the interface 310 may receive incoming units over a wireless link and forward the incoming units to the parser 320. In one embodiment, the interface 310 may receive outgoing data units from the data processing unit 330 and process the outgoing data units before sending the processed outgoing data units over the wireless link. In one embodiment, the operation of the interface 310 may be controlled by the control unit 340.

In one embodiment, the parser 320 may route the incoming units to one of the data processing unit 330 or the control unit 340 based on the content of the incoming units. In one embodiment, the parser 320 may receive incoming units, which may include base-station identifiers and may forward such packets to the control unit 340. In one embodiment, the incoming unit may include a data or voice packet and forward such packets to the data processing unit 330 for further processing. In one embodiment, the data processing unit 330 may process the packets before storing the packets in the memory 335 or may retrieve packets stored in the memory 335 and process the packets before sending the processed packets to the interface 310.

In one embodiment, the scanning engine 350 may scan the network environment 100 in response to receiving a scan initiation signal from the control unit 340. In one embodiment, the scanning engine 350 may receive base-station identifier from one or more base stations such as NFPA 120-B and/or OMBS 140 provisioned in the network environment 100. In one embodiment, the scanning engine 350 may send the identifier units to the control unit 340. In other embodiment, the scanning operation may be performed by the control unit 340 as well.

In one embodiment, the control unit 340 may send a scan initiation signal to the scanning engine 350. In one embodiment, the control unit 340 may receive the base-station identifiers in response to sending the scan initiation signal to the scanning engine 350. In one embodiment, the control unit 340 may store the base-station identifiers in the parameters table 365. In one embodiment, the control unit 340 may determine the power present in the radio signal for each of the base-stations for which the base-station identifiers are received. In one embodiment, the control unit 340 may determine the radio signal strength indicator (RSSI), which may provide an indication of the power of the radio signal between the serving FAP 120-A and the other base-stations such as the NFAP 120-B and the OMBS 140. In one embodiment, the control unit 340 may include a basic circuit to pick-up the basic radio frequency signals and generate an output equivalent to the signal strength. In one embodiment, the control unit 340 may update the RSSI values for the base-stations provisioned in the network environment 100. In one embodiment, the control unit 340 may store the RSSI values associated with the corresponding base-station identifiers (BSID) in the parameters table 365.

In one embodiment, the control unit 340 may provide the base-station identifiers (BSID) and the corresponding RSSIs to the self-organizing network (SON) server 160. In one embodiment, the control unit 340 may receive configuration values from the SON server 160 in response to providing the BSIDs and the corresponding RSSIs. In one embodiment, the control unit 340 may self-configure the serving FAP 120-A by setting the MAC and PHY parameters defined in IEEE® 802.16 Standard using the MAC and PHY parameters received from the SON server 160. In one embodiment, the control unit 340 may store the configuration values corresponding to each BSID in the configuration table 375. In one embodiment, the control unit 340 may further include configuration registers 342, which may be configured with the configuration values to enable the serving FAP 120-A to establish connectivity with the base-stations in the network for which the configuration values may be received.

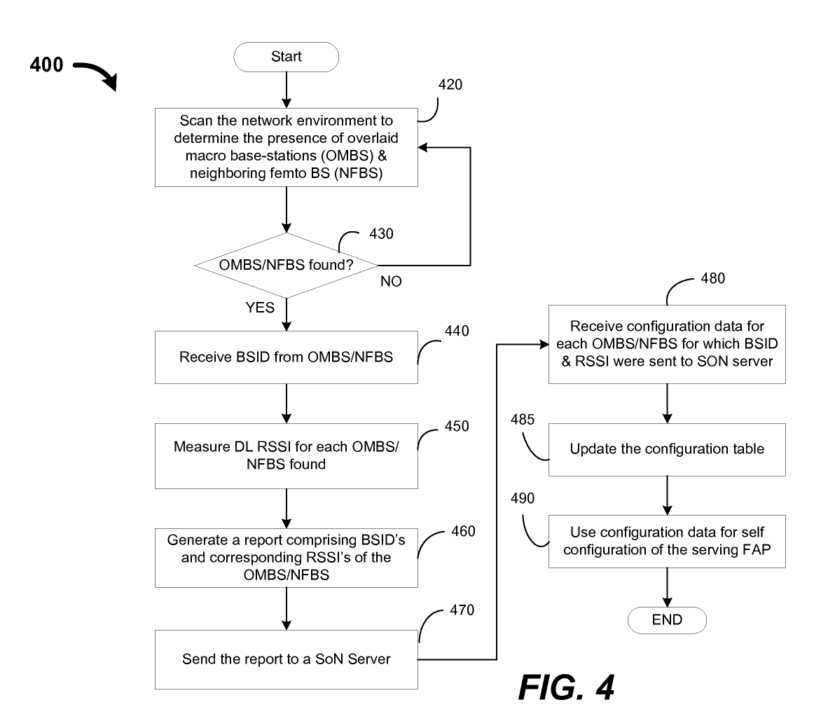

An embodiment of an operation of a serving FAP 120-A that may perform self-configuration is illustrated in flow-chart of FIG. 4. In block 420, the scanning engine 350 may scan the network environment 100 to determine the presence of overlaid macro base-stations such as OMBS 140 and neighboring femtocell access points such as NFAP 120-B.

In block 430, the control unit 340 may determine whether base-stations such as overlaid macro base-stations and neighboring femtocell access points (NFAPs) are found in the network environment 100. Control passes to block 440 if the neighboring base-stations are found and may continue to scan the network at regular intervals as depicted in block 420 otherwise.

In block 440, the control unit 340 may receive information units that may include the base-station identifiers of the neighboring base-stations. In one embodiment, the report from the NFAP 120-B may include an identifier field equaling BSID #2 and the report from the OMBS 140 may include an identifier equal to BSID #1. In one embodiment, the control unit 340 may store the base-station identifiers in the parameters table 365.

In block 450, the control unit 340 may determine or measure the receive signal strength using the information signal sent by the base-stations such as NFPA 120-B and OMBS 140. In one embodiment, the control unit 340 may include basic electronic circuits to measure the strength of the radio frequency signals and provide the measured signals in a format such as RSSI.

In block 460, the control unit 340 may generate a report, which may include the BSIDs of the base-stations and the corresponding RSSI of the base-stations (e.g., NFPA 120-A and OMBS 140) provisioned in the network environment 100. In one embodiment, the report stored in the parameters table 365 may be as depicted in FIG. 5A. In one embodiment, the parameters table 365 may comprise columns BSID 510 and RSSI 515. In one embodiment, the BSID 510 may include identifiers BSID#1, BSID#2, . . . BSID#n of the base-stations. In one embodiment, the identifiers BSID #1 and BSID #2 may, respectively, represent the base-station identifiers of NFAP 120-B and OMBS 140. In one embodiment, the column RSSI 515 may include radio signal strength indicator values X1, X2, . . . Xn. In one embodiment, the RSSI value X1 and X2 may, respectively, represent the RSSI values for the base-stations NFAP 120-B and the OMBS 140.

In block 470, the control unit 340 may send the report to a self-organizing network (SON) server 160. In block 480, the control unit 340 may receive configuration data or configuration values for each base-station that had earlier responded (in block 440) with the base-station identifier. In one embodiment, the control unit 340 may receive the configuration values from the SON server 160 in response to sending the report.

In block 485, the control unit 340 may update the configuration table 475. In one embodiment, the configuration table 375 may be as depicted in FIG. 5B. In one embodiment, the configuration table 375 may include two columns BSID 565 and configuration values 575. In one embodiment, the BSID 565 may include BSID #1, BSID #2 . . . BSID #n and the configuration values 575 may include, for example, channel bandwidth (CBW), fast-fourier transform (FFT) size, cyclic prefix, and such other values.

In block 490, the control unit 340 may use the configuration values to self-configure the serving FAP 120-A. As the result, the serving FAP 120-A may self-configure and operate without any or minimal manual intervention.

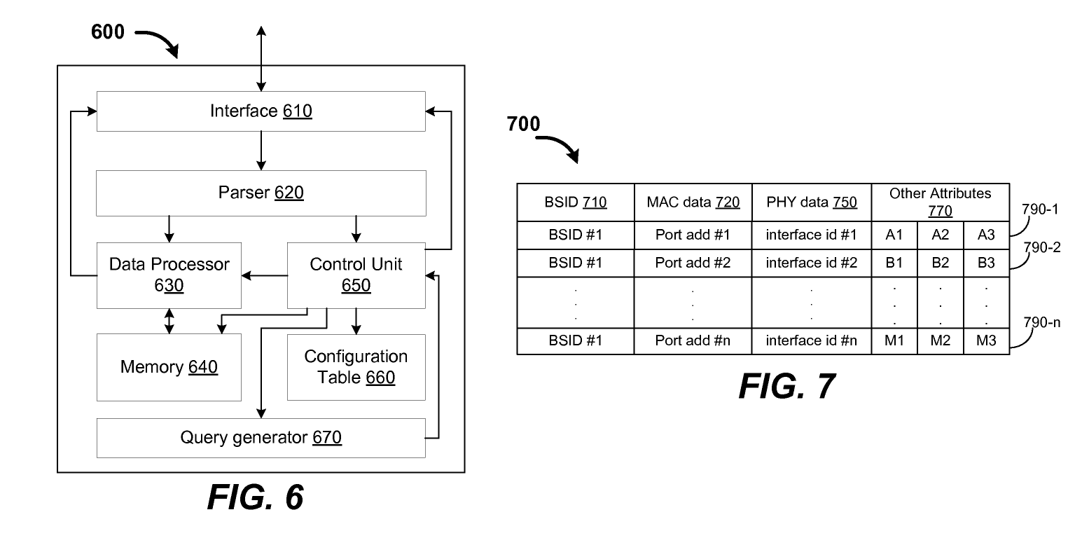

An embodiment of a SON server 160, which may support serving FAP 120-A to perform self-configuration is illustrated in FIG. 6. In one embodiment, the SON server 160 may include an interface 610, a parse 620, a data processing unit 630, a memory 640, a control unit 650, a configuration table 660, and a query generator 670.

In one embodiment, the interface 610 may allow the SON server 160 to communicate with the other blocks in the network environment 100. In one embodiment, the interface 610 may provide electrical, physical, and protocol interfaces to the other blocks in the network 100. In one embodiment, the interface 610 may receive incoming units comprising information such as the list of BSIDs and the corresponding RSSIs received from the serving FAP 120-A and configuration data received from the OAM&P server 180 and forward the incoming units to the parser 620. In one embodiment, the interface 610 may receive outgoing units such as queries or the data units received from the control unit 650 or the data processing unit 630 and send the outgoing units to a next block.

In one embodiment, the parser 620 may route the incoming units to one of the data processing unit 330 or the control unit 340 based on the content of the incoming units. In one embodiment, the parser 320 may receive query signals and may forward queries to the control unit 650. In one embodiment, the data processing unit 630 may process the packets, provided by the parser 620, before storing the packets in the memory 640 or may retrieve the packets stored in the memory 640 and process the packets before sending the processed packets to the interface 610.

In one embodiment, the control unit 650 may receive the base-station identifiers (BSID) and the corresponding RSSIs from the serving FAP 120-A and store the BSIDs in the configuration table 660. In one embodiment, the control unit 650 may provide the BSIDs and a control signal such as a ‘query generate’ signal to the query generator 670. In one embodiment, the control unit 650 may receive one or more queries in response to sending the ‘query generate’ signal. In one embodiment, the control unit 650 may determine the address of the OAM&P server 180 and include the address of the OAM&P server 180 into the one or more queries received from the query generator 670. In one embodiment, the control unit 650 may send the one or more queries to the interface 610, which may forward the one or more queries to the OAM&P server 180.

In one embodiment, the control unit 650 may receive the configuration data from the OAM&P sever 180 in response to sending the one or more queries. In one embodiment, the configuration data may include medium access control (MAC) layer data and physical layer (PHY) data for each of the base-stations for which the BSIDs were included in the query. In one embodiment, the control unit 650 may store the configuration data in the configuration table 660. In one embodiment, the control unit 650 may add, delete, or modify the configuration values stored in the configuration table 660. In one embodiment, the control unit 650 may add other attributes to configuration data for the BSIDs, which were included in to one or more queries. In one embodiment, the control unit 650 may send the configuration values to the interface 610, which in turn may send the configuration values to the serving FAP 120-A.

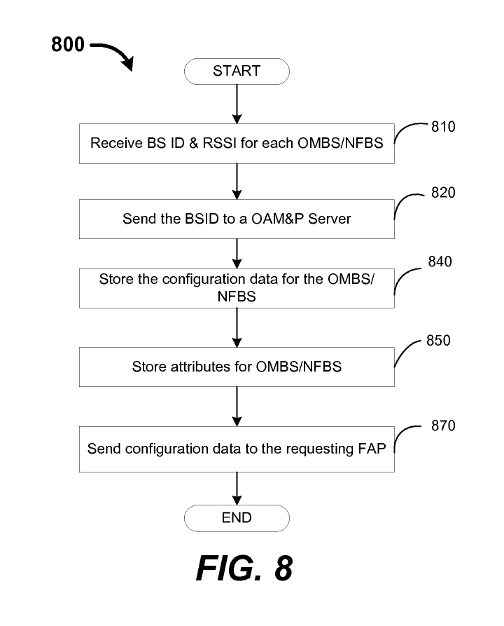

An embodiment of an operation of the SON server 160, which may support the serving FAP 120-A to perform self-configuration is illustrated in flow-chart of FIG. 8. In block 810, the interface 610 may receive the list (or report) of BSIDs and RSSIs from the serving FAP 120-A and may forward the list to the control unit 650.

In block 820, the control unit 650 may send the one or more queries, which may include the BSIDs to the interface 610. In one embodiment, the one or more queries may be forwarded to the OAM&P server 180. Before, the control unit 650 sends the one or more queries, in one embodiment, the control unit 650 may provide the BSIDs received from the serving FAP 120-A and a control signal such as a ‘query generate’ signal to the query generator 670. In one embodiment, the control unit 650 may receive one or more queries in response to sending the ‘query generate’ signal. In one embodiment, the control unit 650 may determine the address of the OAM&P server 180 and include the address of the OAM&P server 180 into the one or more queries received from the query generator 670.

In block 840, the control unit 650 may store the configuration data for the base-stations for which the base-station identifiers were included in the one or more queries. In one embodiment, the control unit 650 may receive the configuration data from the OAM&P sever 180 in response to sending the one or more queries. In one embodiment, the configuration data may include medium access control (MAC) layer data and physical layer (PHY) data for each of the base-stations for which the BSIDs were included in the query. In one embodiment, the control unit 650 may store the configuration data in the configuration table 660.

In block 850, the control unit 650 may include the other attributes to configuration data for the BSIDs, which were included in the one or more queries. In one embodiment, the configuration values stored in the configuration table 660 may be as depicted in the table 700 of FIG. 7. In one embodiment, the table 700 may comprise four columns BSID 710, MAC data 720, PHY data 750, and other attributes 770 and n rows 790-1 to 790-n. In one embodiment, the entries in the row 790-1 may represent config value #1, which may include BSID #1, port #1, interface id #1, and A1, A2, and A3. In one embodiment, the other attributes A1, A2, and A3 may represent channel bandwidth, FFT size, cyclic prefix and such other values.

In one embodiment, the BSID #1 may represent the base-station identifier of one of the base-stations (e.g., NFAP 120-B) in the network environment 100 that responded to a scan signal sent by the serving FAP 120-A. In one embodiment, the port #1 and interface id #1 may, respectively, represent the medium access control layer port address and physical layer address of NFAP 120-B. In one embodiment, the serving FAP 120-A may use the port #1 and interface id#1 to establish connectivity with the NFAP 120-B. Similarly, the entries in row 790-2 may represent config value #2, which may represent the configuration values for another base-station such as OMBS 140 and the serving FAP 120-A may use the config value #2 to establish connectivity with the OMBS 140.

In block 870, the control unit 650 may send the configuration values to the interface 610, which in turn may send the configuration values to the serving FAP 120-A.

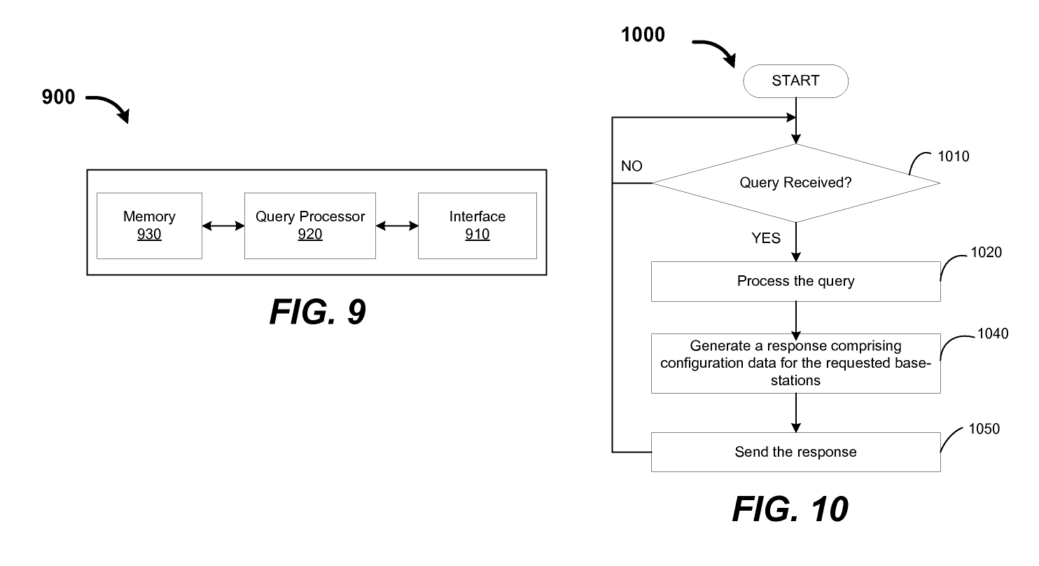

An embodiment of OAM&P server 180, which may support serving FAP 120-A to perform self-configuration is illustrated in FIG. 9. In one embodiment, the OAM&P server 180 may include an interface 910, a query processor 920, and a memory 930.

In one embodiment, the interface 910 may allow the OAM&P server 180 to communicate with the other blocks such as the SON server 160 provisioned in the network environment 100. In one embodiment, the interface 910 may support wired and wireless communications. In one embodiment, the interface 910 may provide electrical, physical, and protocol interfaces to the other blocks in the network 100. In one embodiment, the interface 910 may receive one or more queries from the SON server 160 and forward the queries to the query processor 920. In one embodiment, the interface 910 may receive configuration data from the query processor 920 and forward the configuration data to the SON server 160.

In one embodiment, the query processor 620 may generate configuration data in response to the queries received. In other embodiment, the query processor 620 may retrieve configuration data stored in the memory 630 for each BSID included in the query. In one embodiment, the configuration data may include physical (PHY) layer and medium access control (MAC) layer data. In one embodiment, the configuration data may include port numbers, socket identifiers, interface identifiers, and such other similar values. In one embodiment, the query processor 620 may provide the configuration data to the interface 910.

An embodiment of an operation of the OAM&P server 180, which may support the serving FAP 120-A to perform self-configuration is illustrated in flow-chart of FIG. 10. In block 1010, the interface 910 may check whether a query is received and control passes to block 1030 if the query is received and to block 1010 otherwise.

In block 1030, the query processor 620 may process the query. In one embodiment, the query processor 620 may retrieve the BSIDs included in the query for which the configuration is to be provided.

In block 1040, the query processor 620 may generate a response comprising configuration data for the requested base-station identifiers. In one embodiment, the query processor 620 may retrieve the configuration data stored in the memory 630 and prepare a response based on the configuration data. In one embodiment, the query processor 620 may send the response to the SON server 160.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method to self-configure a femtocell access point, comprising:
receiving a plurality of base-station identifiers from base-stations provisioned in a network in response to scanning the network,
determining radio signal strength indicator values for the base-stations for which the base-station identifiers are received,
sending the plurality of base-station identifiers and the radio signal strength indicator values to a first server,
receiving configuration values from the first server in response to sending the plurality of base-station identifiers and the radio signal strength indicator values, and
self-configuring the femtocell access point using the configuration values.

2. The method of claim 1, wherein the plurality of base-station identifiers are received in a down-link broadcast message.

3. The method of claim 1 further comprises sending one or more queries from a first server to a second server, wherein the one or more queries include the plurality of base-station identifiers.

4. The method of claim 3 comprises receiving configuration data from the second server for the plurality of base-station identifiers included in the one or more queries.

5. The method of claim 4, wherein the configuration data includes medium access control layer data and physical layer data.

6. The method of claim 4 comprises identifying a set of base-stations, which have radio signal strength indicator values above a handoff threshold.

7. The method of claim 6, wherein the set of base-stations may be changed dynamically to include other base-stations if the radio signal strength indicators for the other base-stations increases beyond the handoff threshold.

8. The method of claim 6 comprises determining configuration values for the set of base-stations using the configuration data received from the second server.

9. The method of claim 8 comprises sending the configuration values for the set of base-stations to the serving femtocell access point.

10. The method of claim 9 comprises configuring the serving femtocell access point using the configuration values to enable the serving femtocell access point to establish connectivity with the set of base-stations.

11. A femtocell access point to perform self-configuration, comprising:
an interface,
a control unit coupled to the interface, and
a scanning engine coupled to the interface and the control engine,
wherein the scanning engine is to scan neighboring base-stations in response to receiving an indication from the control unit,
wherein the control unit is to,
receive a plurality of base-station identifiers from the neighboring base-stations provisioned in a network after scanning,
determine radio signal strength indicator values for the base-stations for which the plurality of base-station identifiers are received,
store the plurality of base-station identifiers and the radio signal strength indicator values in a parameters table,
send the plurality of base-station identifiers and the radio signal strength indicator values to a first server,
receive configuration values from the first server in response to sending the plurality of base-station identifiers and the radio signal strength indicator values, and
self-configure the femtocell access point using the configuration values.

12. The femtocell access point of claim 11, wherein the control unit is to receive the plurality of base-station identifiers included in a down-link broadcast message from the base-stations.

13. The femtocell access point of claim 12, wherein the control unit is to determine the radio signal strength indicator values based on the strength of signals received from the base-stations.

14. The femtocell access point of claim 11, wherein the control unit is to receive the configuration values for a set of base-stations selected from the base-stations provisioned in the network.

15. The femtocell access point of claim 14, the control unit further comprises one or more configuration registers, wherein the control unit is to configure the one or more configuration registers with the configuration values to enable the femtocell access point to establish connectivity with the set of base-stations.

16. A self-organizing network server, comprising:
an interface,
a control unit coupled to the interface, and
a query generator coupled to the control unit,
wherein the control unit is to,
receive a plurality of base-station identifiers of base-stations provisioned in a network and radio signal strength indicator values for the base-stations,
send a control signal and the plurality of base-station identifiers to the query generator,
send one or more queries over the interface in response to receiving the one or more queries from the query generator,
wherein the query generator is to generate the one or more queries in response to receiving the control signal, wherein the one or more queries include the plurality of base-station identifiers.

17. The self-organizing network server of claim 16, wherein the control unit is to receive configuration data for the plurality of base-station identifiers included in the one or more queries in response to sending the one or more queries, wherein the configuration data includes medium access control layer and physical layer data.

18. The self-organizing network server of claim 16, wherein the control unit is to identify a set of base-stations, which have radio signal strength indicator values above a handoff threshold.

19. The self-organizing network server of claim 18, wherein the control unit is to change the set of base-stations dynamically to include other base-stations if the radio signal strength indicators for the other base-stations increases beyond the handoff threshold.

20. The self-organizing network server of claim 18, wherein the control unit is to determine the configuration values for the set of base-stations using the configuration data of the base-stations included in the configuration data provided for the base-stations.
